(19) United States
(12) Patent Application Publication
(10) Pub. No.: US 2004/0151979 A1
(43) Pub. Date: Aug. 5, 2004

(54) Battery pack for use with a hand-held debridement device

(76) Inventor: Timothy A. Donaldson, Massillon, OH (US)

Correspondence Address: BAKER & DANIELS, 111 E. WAYNE STREET, SUITE 800, FORT WAYNE, IN, 46802

(21) Appl. No.: 10/356,913

(22) Filed: Feb. 3, 2003

(51) Int. Cl. H01M 2/10

(52) U.S. Cl. 429/99; 429/100

(57) ABSTRACT

A battery pack for use with hand-held wound debridement devices. The battery pack of the present invention stores a plurality of batteries such that the longitudinal axes of the batteries are substantially coplanar with one another, thereby reducing the risk of undesired contact between the batteries and opposing terminals. By securing the batteries in this arrangement, the risk of electrical shorts within the battery pack is greatly reduced. The battery pack further includes a hinge mechanism for allowing the cover portion to be engaged with the base portion and retained in an open or a closed position. Advantageously, this hinge mechanism allows the cover and the base to be in engagement with one another while the wires are being tucked just prior to closing the battery pack.

### BACKGROUND OF THE INVENTION

1. Field of the Invention

The present invention relates generally to hand-held wound debridement devices, and, more particularly, to a battery pack for powering such devices.

2. Description of the Related Art

Debridement is the surgical excision of dead, devitalized, and contaminated tissue, and/or the removal of foreign matter from a wound. Hand-held wound debridement systems such as, e.g., the Pulsavac® wound debridement systems available from Zimmer, Inc. utilize streams of fluid together with suction to effect wound debridement. In these systems, the fluid streams dislodge dead, devitalized, and contaminated tissue, as well as foreign matter. After the unwanted tissue and foreign matter is dislodged, it is removed by the suction provided by the debridement system. It is advantageous for such hand-held wound irrigation systems to be battery powered so that they are portable.

Some conventional battery packs adapted for use with hand-held debridement devices are configured such that the batteries lie in two substantially parallel planes, one atop the other. In this arrangement, batteries and battery terminals oppose one another, and, therefore, opposing batteries and battery terminals may come into contact. If opposing batteries and battery terminals come into contact, electrical shorts may occur within the battery pack. This design is also disadvantageous because it results in a battery pack which is bulky and unwieldy.

Yet another disadvantage associated with conventional battery packs relates to the difficulty with which these conventional packs are closed. With reference to FIG. 1, prior art battery pack 2 includes base and cover components 3, 4. Base and cover components 3, 4 include latches for securing the base component to the cover component, such that a number of batteries 5 and terminals 6 oppose one another. When it is desired to close battery pack 2, wires 7 must be positioned within battery pack 2 while base and cover components 3, 4 are engaged with one another. It is difficult and time consuming for the user to tuck the conducting wires into the battery pack while at the same time, snapping the cover and base components together.

What is needed in the art is a battery pack having its batteries and terminals positioned such that the battery pack is not prone to electrical shorts.

Also needed in the art is a battery pack which is not likely to come apart when dropped, and which allows the user to easily position and retain the internal conducting wires so as to not interfere with closure of the battery pack.

### SUMMARY OF THE INVENTION

The present invention is a battery pack for use with hand-held debridement devices, including, e.g., Zimmer's Pulsavac® hand-held debridement devices including the Pulsavac® Plus. The battery pack of the present invention includes a base and a cover. The base includes a pair of sidewalls, a pair of endwalls, and an internal cavity. The internal cavity is adapted to hold a plurality of batteries, e.g., AA (1.5 V) batteries. The bottom surface of the internal cavity includes a plurality of guide ribs for holding the batteries such that their longitudinal axes are coplanar.

The internal cavity further includes a pair of support ribs. One support rib is disposed substantially parallel and adjacent to each of the side walls. The support ribs are spaced from the sidewalls. At least one of the spaces between an adjacent sidewall/support rib pair is utilized to retain and prevent the conducting wires from interfering with closure of the battery pack.

A plurality of removable terminal clips are mounted on each of the support ribs. Each terminal clip includes a tab operable to engage a wire connector of a conducting wire. The tabs are constructed to help retain the wires within the space between the support rib and the side wall. Each terminal clip further includes at least one contact element for contacting a battery terminal. Advantageously, the terminal clips may be individually removed and replaced, for example, in the case of damage or wear.

Three wires are provided for wiring the batteries in series to provide high and low speed connections. Specifically, common high speed, and low speed wires are utilized. For example, in a battery pack having eight batteries, the common wire attaches to the terminal in contact with the negative terminal of the first battery, the high speed wire attaches to the terminal in contact with the positive terminal of the eighth battery, and the low speed wire attaches to the terminal in contact with the positive terminal of the fourth battery.

One of the end walls of the base includes an opening adapted to receive the conducting wires as they exit the battery back. Before exiting the battery pack, the conducting wires are collected and positioned within an outer wire casing which is then positioned within a space formed between an adjacent side wall/support rib pair. As indicated above, the conducting wires are retained in the aforementioned space by the tabs of the terminal clips. When the cover and the base are engaged to close the battery pack, the cover and the base cooperate to create an interference fit and retain the wires in the opening through which they exit the base. This arrangement results in an integrated strain relief, and obviates the need for any external strain relief element.

The base and cover portions of the battery pack further include a hinge mechanism allowing the battery pack to remain in an open configuration with the cover engaged with the base while the wires are tucked into the space between the support rib and the side wall of the base. The structure allowing the battery pack to remain in an open configuration with the cover engaged with the base generally comprises a slot having a stepped surface formed in the base portion, and a lip extending from an end wall of the cover. In use, the cover is operably engaged with the base by first inserting a distal end of the lip into the slot.

To initially position the lip in the slot, the lip must be substantially transverse to the opening allowing access to the slot, as the geometry of the lip otherwise prevents insertion of the lip into the slot. For the purposes of this document, “substantially transverse” describes an arrangement in which a pair of components are perpendicular, one to another, or no more than 40° out of perpendicular, i.e., the pair of components form an angle of 50° to 130°. After positioning the distal end of the lip through the opening to the slot, the distal end of the lip travels to a terminal wall of the slot opposing the opening thereof. At this point, the cover can rotate toward the base, i.e., to a position in which the cover and the base form an acute angle. At a certain point of rotation, the cooperating geometries of the slot, the lip, and an endwall of the cover will act to maintain the position of the cover open above the base.

In one exemplary embodiment, the cover is maintained in an open position in which the cover and the base form an angle of about 60°. After the conducting wires are collected in a wire casing, positioned between an adjacent sidewall/support rib pair, and positioned through the endwall opening described above, the cover is positioned atop the base to complete closure of the battery pack. To move the cover from the open position in which it is held by the cooperating geometries of the slot and the lip, force is applied to the cover a distance from the lip to overcome the resistance to movement supplied by the cooperating lip/slot geometry. Responsive to the aforementioned supplied force, the cover moves into a closed position atop the base. In the closed position, the lip is contained in the slot. The stepped surface is configured whereby a portion of the interior wall of the slot on which the stepped surface is formed is positioned adjacent the lip so that the lip and the aforementioned portion of the interior wall form cooperating shoulders preventing relative displacement of the cover and base, unless the shoulders are moved out of cooperating engagement by, e.g., movement of an opposite end of the cover, i.e., the end of the cover opposite the lip and away from the base.

To complete closure of the battery pack, a fastener is utilized to affix the cover to the base. Generally the fastener is positioned a distance from the lip/slot combination to resist movement of the end of the cover opposite the lip away from the base. In one embodiment, the fastener comprises a screw. The fastener cooperates with the lip/slot combination to maintain closure of the battery pack. The closure mechanism helps to ensure that the battery pack remains assembled in the event that it is dropped.

An object of the present invention is to provide a battery pack in which the batteries and battery pack terminals are not positioned opposite each other, and therefore do not have an opportunity to come into contact with one another, thereby reducing the risk of electrical shorts within the battery pack.

Another object of the present invention is to provide a battery pack having a hinge mechanism for allowing the base and cover portions to be engaged in an open position while the wires are positioned within the perimeter of the battery pack prior to closure of the battery pack.

Yet another object of the present invention is to provide a battery pack that will not open if dropped.

### BRIEF DESCRIPTION OF THE DRAWINGS

The aforementioned and other features and objects of this invention, and the manner of attaining them, will become apparent and the invention itself will be better understood by reference to the following description of an embodiment of the invention taken in conjunction with the accompanying drawings, wherein:

FIG. 1 is a perspective view of a prior art battery pack in an open position;

FIG. 2 is a perspective view of the battery pack of the present invention in an open position;

FIG. 3 is a sectional view thereof taken along line 3-3 of FIG. 2.

FIG. 4 is a sectional view thereof taken along line 4-4 of FIG. 3; and

FIG. 5 is an enlarged fragmentary view of the hinge mechanism of the battery pack shown in FIGS. 2-4.

Corresponding reference characters indicate corresponding parts throughout the several views. Although the drawings represent an embodiment of the present invention, the drawings are not necessarily to scale and certain features may be exaggerated in order to better illustrate and explain the present invention. The exemplification set out herein illustrates an embodiment of the invention, in one form, and such exemplification is not to be construed as limiting the scope of the invention in any manner.

### DETAILED DESCRIPTION OF THE PRESENT INVENTION

The embodiments disclosed below are not intended to be exhaustive or to limit the invention to the precise form disclosed in the detailed description. Rather, the embodiments are chosen and described so that others skilled in the art might utilize their teachings.

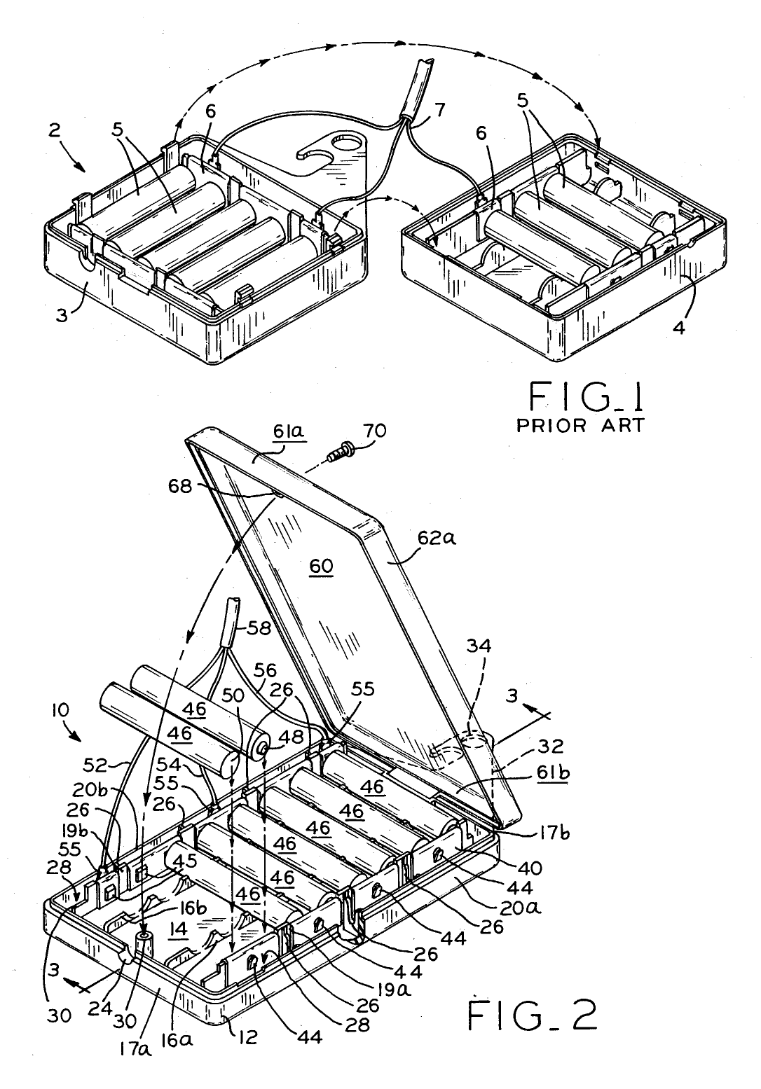

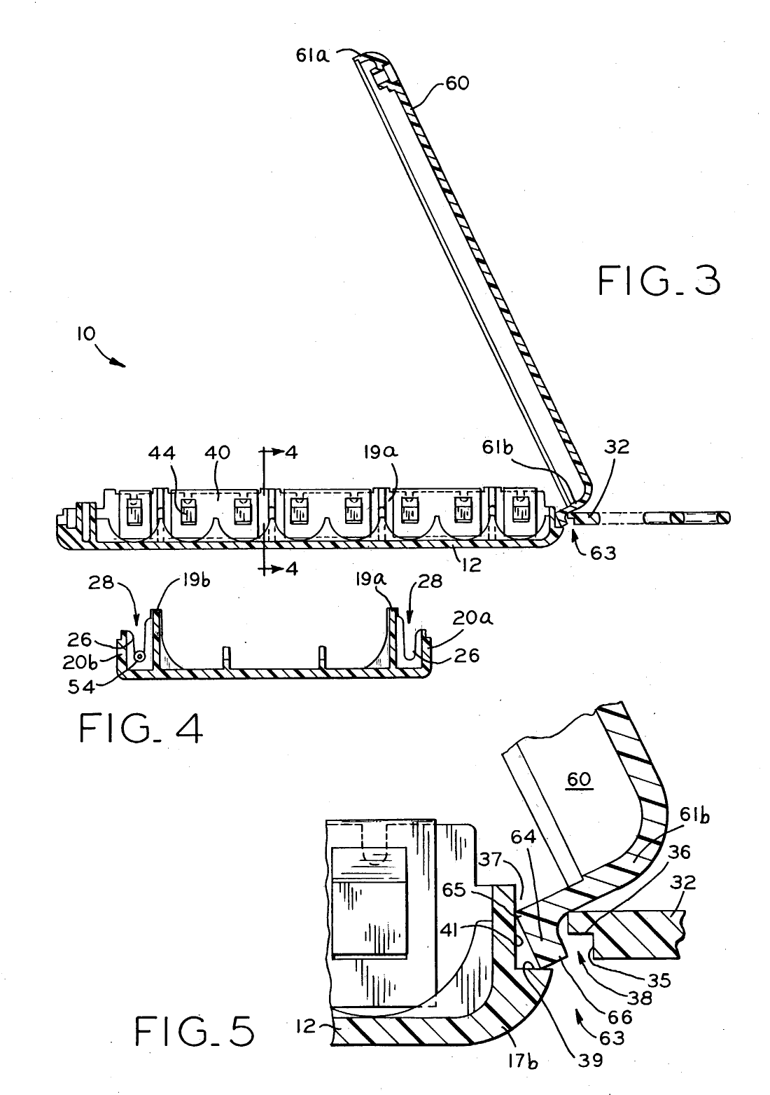

FIG. 2 is a perspective view of battery pack 10 of the present invention in an open position. Battery pack 10 may be manufactured from a variety of plastics. Battery pack 10 is substantially rectangular in shape, and includes base 12 and cover 60. Base 12 includes a pair of endwalls 17a, 17b and a pair of sidewalls 20a, 20b. Endwall 17b of base 12 extends into hook 32, which may include opening 34. One or both of hook 32 and opening 34 may be utilized to hang or otherwise attach battery pack 10 to a desired article, e.g., tubing, bed rails, etc. Base 12 further comprises internal cavity 14 having guide ribs 16a, 16b molded therein for holding batteries 46 in the desired coplanar arrangement. Cover 60 comprises a pair of end walls 61 a, 61 b, and a pair of sidewalls 62a, 62b.

Battery pack 10 holds eight AA batteries wired in series. Batteries 46 are connected to three conductor wires. Specifically, the batteries 46 are connected to common wire 56, low speed wire 54, and high-speed wire 52. Each wire 52, 54, and 56 has a wire connector 55 affixed to a distal end thereof Common wire 56 attaches to the terminal clip (40) in contact with the negative terminal of the first battery. Low speed wire 54 attaches to the terminal clip (40) in contact with the positive terminal of the fourth battery. High speed wire 56 attaches to the terminal clip (40) in contact with the positive terminal of the eighth battery. Wires 52, 54, and 56 are bound together by wire casing 58. In addition to engaging wire connectors 55, tabs 44 also help to hold wires 52, 54, and 56 within recesses 28, such that they are out of the way when battery pack 10 is opened and closed.

A pair of support ribs 19a, 19b are molded along the bottom of internal cavity 14 of base 12, and run substantially parallel to sidewalls 20a, 20b of base 12. Support ribs 19a, 19b are spaced from sidewalls 20a, 20b, respectively, such that recesses 28 are formed therebetween. As can best be seen with reference to FIG. 4, a plurality of inserts 26 are positioned in recesses 28. Inserts 26 are adapted to assist in retaining wires 52, 54, and 56 within recesses 28. By retaining and storing wires 52, 54, and 56 within one of recesses 28, battery pack 10 can be easily opened and closed.

Wires 52, 54 and 56, and wire casing 58 is positioned in a recess (28). Wire casing 58 is bent at a substantially 90° angle, runs along end wall 17a, and exits battery pack 10 through opening 24 disposed in endwall 17a of base 12. Endwall 61 a of cover 60 includes projection 68 aligned with opening 24. When battery pack 10 is closed, projection 68 exerts pressure upon wire casing 58, such that an interference fit is created. Advantageously, this arrangement provides for integrated strain relief, and therefore obviates the need for any additional strain relief structure.

Terminal clips 40 are press fit onto support ribs 19a, 19b. Each terminal clip 40 includes tab 44 and at least one contact element 45. In use, contact elements 45 allow batteries 46 to be arranged in series by contacting terminals 48, 50 of batteries 46 as illustrated in FIG. 2.

Advantageously, terminal clips 40 are removable and replaceable. Therefore, if one or more terminal clips 40 is damaged or worn, new terminal clips 40 may be applied. For example, terminal clips 40 may become damaged or deformed from continued use, and may therefore fail to properly electrically connect batteries 46 and wires 52, 54, and 56. Terminal clips 40 may be manufactured from, e.g., brass or any suitable conducting material.

With reference to FIGS. 4 and 5, base 12 and cover 60 of battery pack 10 further include hinge mechanism 63 for allowing battery pack 10 to remain in an open configuration with cover 60 engaged with base 12. Hinge mechanism 63 is disposed between endwall 17b of base 12 and hook 32, and includes L-shaped slot 38 having stepped surface 36. Lip 64 extends from end wall 61b of cover 60 and forms a part of hinge mechanism 63. In use, cover 60 is operably engaged with base 12 by inserting distal end 66 of lip 64 through opening 37 and into L-shaped slot 38 of base 12. To initially position lip 64 into slot 38, lip 64 is positioned substantially transverse to opening 37 of slot 38, as the geometry of lip 64 otherwise prevents insertion of lip 64 into slot 38. To position lip 64 substantially transverse to opening 37, cover 60 is likewise substantially transverse to base 12.

After positioning distal end 66 of lip 64 through endwall opening 37 and into slot 38, distal end 66 of lip 64 travels to terminal wall 39 opposing opening 37. At this point, cover 60 is free to rotate toward base 12 until corner 65 contacts vertical wall 41. At this point, the cooperating geometries of slot 38, and lip 64 act to maintain the position of cover 60. In one exemplary embodiment, cover 60 is maintained in a position in which cover 60 and base 12 form an angle of about 60°. After conducting wires 52, 54, and 56 are positioned in a recess (28) as described above, cover 60 is positioned atop base 12 to complete closure of battery pack 10.

To move cover 60 from the open position described above, force is applied to cover 60 a distance from lip 64 to overcome the resistance to movement supplied by the cooperating lip/slot geometry. Responsive to the aforementioned supplied force, cover 60 moves into a closed position atop base 12. In this position, lip 64 is contained in slot 38, with distal end 66 of lip 64 positioned adjacent interior wall 35 of slot 38. Stepped surface 36 is configured whereby a portion thereof is positioned adjacent lip 64, such that lip 64 and the aforementioned portion of stepped surface 36 form cooperating shoulders preventing relative displacement of cover 60 and base 12 when cover 60 is in a closed position atop base 12.

To complete closure of battery pack 10, fastener 70 is utilized to affix cover 60 to base 12. Generally, fastener 70 is positioned a distance from the lip/slot combination to resist movement of the end of cover 60 opposite lip 64 and away from base 12. In one embodiment, fastener 70 comprises a screw. The closure mechanism helps to ensure that battery pack 12 remains assembled in the event that it is dropped.

In an exemplary embodiment, hollow, threaded boss 30 is positioned on base 12 within internal cavity 14. Aperture 68 in cover 60 is aligned with boss 30, and, when cover 60 is in its closed position, screw 70 can be inserted through aperture 68 and threaded into boss 30. In this manner, cover 60 is secured to base 12.

While this invention has been described as having an exemplary design, the present invention may be further modified within the spirit and scope of the disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A battery pack for use with a handheld debridement device, comprising:
a cover;
a base, said base including a pair of endwalls, and a pair of sidewalls, said endwalls and said sidewalls defining an internal cavity;
a plurality of terminal clips;
a pair of support ribs connected to said base and disposed in said internal cavity, each said terminal clip positioned atop one of said support ribs, said support ribs spaced a distance, one from the other, said distance sized to allow placement of a plurality of batteries between said support ribs; and
a hinge mechanism comprising:
an L-shaped slot formed in said base, said slot including an opening providing access to said slot said opening defining an opening distance;
a lip extending from said cover, said lip including a distal end sized for insertion through said opening, said lip having a length greater than said opening distance.

2. The battery pack of claim 1, further comprising:
a plurality of wire conductors, each said wire conductor connected to a terminal clip; and
retaining means for retaining said wire conductors in said base.

3. The battery pack of claim 2, further comprising:
a wire casing containing said plurality of wire conductors, and wherein said retaining means comprises a plurality of inserts disposed in said internal cavity of said base, each said insert positioned between one of said support ribs and one of said sidewalls of said base, said inserts including tapered cutouts, said tapered cutouts tapering to a retention point sized to create an interference fit with said wire casing.

4. The battery pack of claim 2, wherein each said terminal clip includes a tab extending obliquely therefrom, said tab comprising said retaining means.

5. The battery pack of claim 2, further comprising:
a wire casing containing said plurality of wire conductors, and wherein said base includes an opening sized to accommodate said wire casing and create an interference fit therewith when said cover is positioned atop said base.

6. A battery pack for use with a handheld debridement device, comprising:
a cover;
a base, said base including a pair of endwalls, and a pair of sidewalls, said endwalls and said sidewalls defining an internal cavity;
a plurality of terminal clips;
a pair of support ribs connected to said base and disposed in said internal cavity, each said terminal clip positioned atop one of said support ribs, said support ribs spaced a distance one from the other, said distance sized to allow placement of a plurality of batteries between said support ribs; and
hinge means for hingedly connecting said cover to said base and retaining said cover in one of an open and a closed position.

7. The battery pack of claim 6, wherein said hinge means comprises:
an L-shaped slot formed in said base, said slot including an opening providing access to said slot, said opening defining an opening distance;
a lip extending from said cover, said lip including a distal end sized for insertion through said opening, said lip having a length greater than said opening distance.

8. The battery pack of claim 6, further comprising:
a plurality of wire conductors, each said wire conductor connected to a terminal clip; and
retaining means for retaining said wire conductors in said base.

9. The battery pack of claim 8, further comprising:
a wire casing containing said plurality of wire conductors, and wherein said retaining means comprises a plurality of inserts disposed in said internal cavity of said base, each said insert positioned between one of said support ribs and one of said sidewalls of said base, said inserts including tapered cutouts, said tapered cutouts tapering to a retention point sized to create an interference fit with said wire casing.

10. The battery pack of claim 8, wherein each said terminal clip includes a tab extending obliquely therefrom, said tab comprising said retaining means.

11. The battery pack of claim 8, further comprising:
a wire casing containing said plurality of wire conductors, and wherein said base includes an opening sized to accommodate said wire casing and create an interference fit therewith when said cover is positioned atop said base.
